(19) United States
(12) Patent Application Publication
(10) Pub. No.: US 2002/0096006 A1
(43) Pub. Date: Jul. 25, 2002

(54) Starter wheel for a motor vehicle

(76) Inventors: Hartwig Hahlbrock, Ahlen (DE); Jurgen Speck, Ahlen (DE)

Correspondence Address: COLLARD & ROE, P.C., 1077 Northern Boulevard, Roslyn, NY, 11576-1696, US

(21) Appl. No.: 09/960,235

(22) Filed: Sep. 21, 2001

(30) Foreign Application Priority Data
Sep. 23, 2000 (DE) 100 47 242.7

(51) Int. Cl. F16H 55/12

(52) U.S. Cl. 74/446

(57) ABSTRACT

A starter wheel is provided for a motor vehicle or the like that is connected with twisting strength to a motor shaft. The starter wheel includes a starter element with which an outer toothed rim is associated. A driver element is connected with the starter element on the one hand, and to the converter of an automatic transmission on the other. The improved starter wheel is capable of absorbing radial and primarily axial forces without adversely affecting the operational efficiency. To accomplish this absorption, the driver element includes rocker areas located adjacent to the toothed rim of the starter in the area of the connecting elements which connect the driver element with the converter, such areas bulging outwards in the axial direction.

### CROSS REFERENCE TO RELATED APPLICATIONS

Applicants claim priority under 35 U.S.C. §119 of German Application No. 100 47 242.7 filed Sep. 23, 2000.

### BACKGROUND OF THE INVENTION

1. Field of the Invention

The present invention relates to a starter wheel for a motor vehicle or the like that is connected with twisting or torsional strength to an engine shaft. The starter wheel includes a starter element, with which an outer starter ring is associated, and a driver element that is connected to the starter element, and to the converter of an automatic transmission.

2. The Prior Art

Starter wheels of this type serve for starting the engine of the motor vehicle, and to transmit the driving force from the engine to the transmission via the converter. The driver element has an outwardly curved shape in the area of the opening for securing it on the converter, so that defined axial and radial forces can be absorbed in the installed condition. The driver element is first manufactured as an individual, separate component and fastened on the starter disk only when the motor vehicle is assembled. A drawback with such a starter wheel is high assembly expenditure when the motor vehicle is assembled. Furthermore, the shape of the driver ring requires relatively much space, which is a disadvantage as well.

A starter wheel of the type specified above is known from DE 42 11 472 C2 of this Applicant. This known starter wheel includes a starter disk with a hub and a driver element connected with twisting strength with the starter disk. The driver element includes connecting means for joining it with twisting strength with a converter of the automatic transmission, whereby the driver element has the form of a ring that is secured on the starter disk. In this connection, the driver element bulges outwardly in the area of the connecting means. These outwardly bulging elements engage correspondingly arranged, recessed window openings, or recesses. Owing to such indirect transmission of power from the engine to the hub of the starter disk, and then from the hub to the mounted driver ring, as well as subsequently from the driver ring to the converter of the automatic transmission, superior alternating axial and radial strength is achieved versus other starter wheels. The superior strength is achieved because radial and axial movements are substantially acting only within the area of the outwardly bulging elements of the driver ring. However, such alternating bending strength is still inadequate in certain areas of application.

Therefore, the problem of the invention is to improve a starter wheel of the type specified above so that it is capable of absorbing radial and primarily axial forces without adversely affecting the operational efficiency.

### SUMMARY OF THE INVENTION

The problem is solved according to the invention by modifying a starter wheel of the type specified above so that adjacent to the toothed starter ring, the driver element has rocker-like areas located in the area where the connecting elements are joined with the converter. The rocker areas bulge outwards in the axial direction.

Thus the starter wheel is secured in a fixed manner on the motor shaft above its hub areas. The connection with the converter via the driver element is established via rocker-like areas bulging outwards in the axial direction. owing to their rocker-like design, the rocker areas permit both radial and primarily also axial flexibility, so that radial and axial forces can be absorbed. The desired initial stress or spring characteristic can be influenced in this manner in a targeted manner depending on the design of the rocker-like areas.

According to a first embodiment, the ring-shaped starter element and the driver disk are provided with fastening openings. The fastening openings serve as connecting means for jointly securing the starter element and the driver disk on the converter. In this embodiment, the starter wheel thus includes two structural components that are connected to each other in the area of the fastening openings.

To facilitate mounting of the starter wheel on the vehicle in this embodiment, the starter element and the driver disk are advantageously fixed on one another in the area of the fastening openings. This can be achieved in different ways. For example, the edge of the bores of the fastening openings in the driver disk can be reshaped so as to extend into the corresponding fastening openings on the starter element. A one-piece component is then available for mounting it on the vehicle.

In another, alternative embodiment, the starter element takes the form of an integral component of the driver element. In this way, the starter element forms one single component with the driver element. The rocker areas are then punched out in areas and bulged outwards accordingly.

In another alternative embodiment, the starter element has the shape of a disk, the driver element has the form of a ring, and the driver element is connected with the starter element between the rocker-like areas. The ring-shaped driver element, for example, may be screwed to the disk-shaped area of the starter element.

In order to increase the flexibility of the starter wheel, the driver element may advantageously include a multitude of relief bores distributed over its surface area. The relief bores are advantageously arranged in a regular manner, and some of these relief bores may take the form of oblong holes.

Furthermore, it was found advantageous if relief bores are located between the rocker areas in about the same radius as the fastening openings.

### BRIEF DESCRIPTION OF THE DRAWINGS

Other objects and features of the present invention will become apparent from the following detailed description considered in conjunction with the accompanying drawings which disclose specific embodiments of the present invention. It should be understood, however, that the drawings are designed for the purpose of illustration only and not as a definition of the limits of the invention.

In the drawings, wherein similar reference characters denote similar elements throughout the figures:

FIG. 1 is a perspective representation of a first embodiment of a starter wheel.

FIG. 2 is a side view of the starter wheel according to FIG. 1.

FIG. 3 shows a section according to line III-III in FIG. 2.

FIG. 4 shows an enlarged detail of FIG. 3.

FIG. 5 shows a side view of a second embodiment of a starter wheel; and

FIG. 6 shows a section according to line VI-VI in FIG. 5.

### DETAILED DESCRIPTION OF PREFERRED EMBODIMENTS

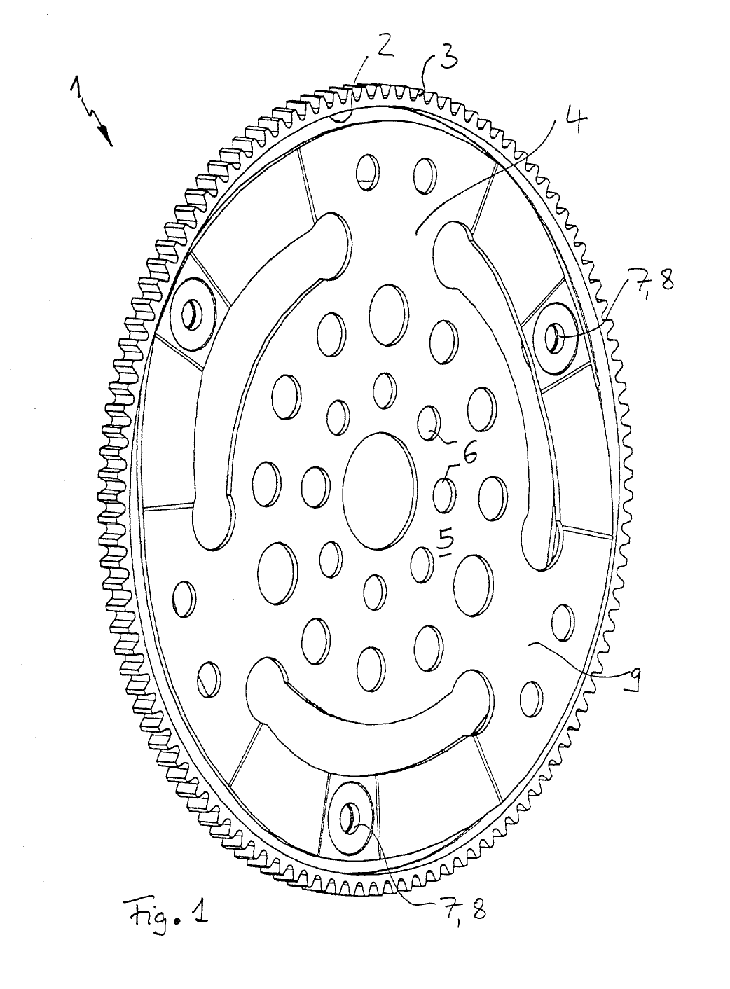

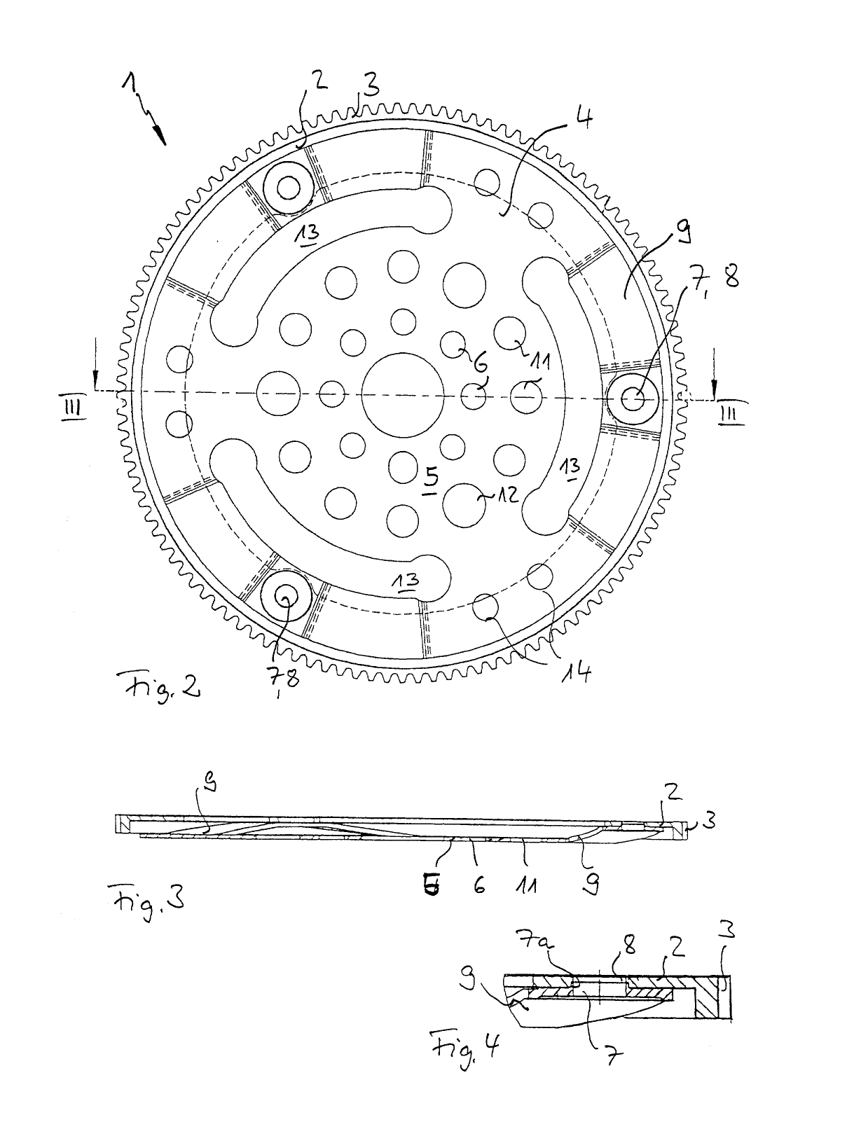

Turning now in detail to the drawings, FIG. 1 shows a starter wheel as defined by the invention for a motor vehicle or the like generally denoted by reference numeral 1. In the embodiment according to FIGS. 1 to 4, the starter wheel includes two components consisting of a ring-shaped starter element 2 with the toothed rim 3 on the outer circumference of starter element 2, and a driver disk 4. Driver disk 4 has an inner hub area 5 for securing it on a motor shaft (not shown), For this purpose, hub area 5 is provided with fastening bores 6 arranged in a circular ring.

Driver disk 4 is connected with twisting strength to starter element 2 and to the converter (not shown) of an automatic transmission. For this purpose, the driver disk is provided with connecting means that preferably takes the form of fastening openings 7 located along its outer circumference. The ring-shaped starter element 2 includes fastening openings 8 located in the same sites as well. In order to preassemble the two components before they are installed in a motor vehicle, driver disk 4 and starter element 2 are preferably fixed on one another in the area of fastening openings 7, 8. For this purpose the bore edges 7a of fastening openings 7 of driver disk 4, for example, are reshaped so as to extend into fastening openings 8 of starter element 2. Although starter wheel 1 thus includes two structural components, starter wheel 1 can be handled as one single structural component when it is installed on the vehicle because the two structural components (starter element 2 and driver disk 4) are secured on each other. The two components are finally connected with the converter in the assembly process by mounting fastening screws extending through fastening openings 7 and 8.

It is particularly important in connecting starter wheel 1 as defined by the invention with the converter that driver disk 4 include the rocker-like areas 9. Rocker areas 9 are located adjacent to toothed starter rim 3 in the area of connecting means 7 and 8 and bulge outwards in the axial direction. In this way, driver disk 4 is arranged axially spaced in its rocker-like areas 9 from the plane surface of starter element 2. The consequence is that the fastening plane is arranged axially spaced from the fastening plane of the hub in relation to the converter. Rocker-like areas 9 have a defined flexibility that can be adjusted depending on the dimensioning and material selection. Hence, starter wheel 1 is able to absorb to a notable extent and without any damage axial forces as well as radial forces.

In order to further increase the flexibility of starter wheel 1, driver disk 4 has distributed over its surface area a multitude of drilled relief holes, or bores, which may be arranged in a regular manner. For example, first relief bores 11, 12 may be provided adjacent to fastening bores 6. First relief bores 11, 12 are adjoined by oblong hole-type bores 13 located adjacent thereto radially on the outside. Furthermore, it is important that additional relief bores 14 are provided, which are located between rocker-like areas 9 within about the same radius as fastening openings 7 and 8.

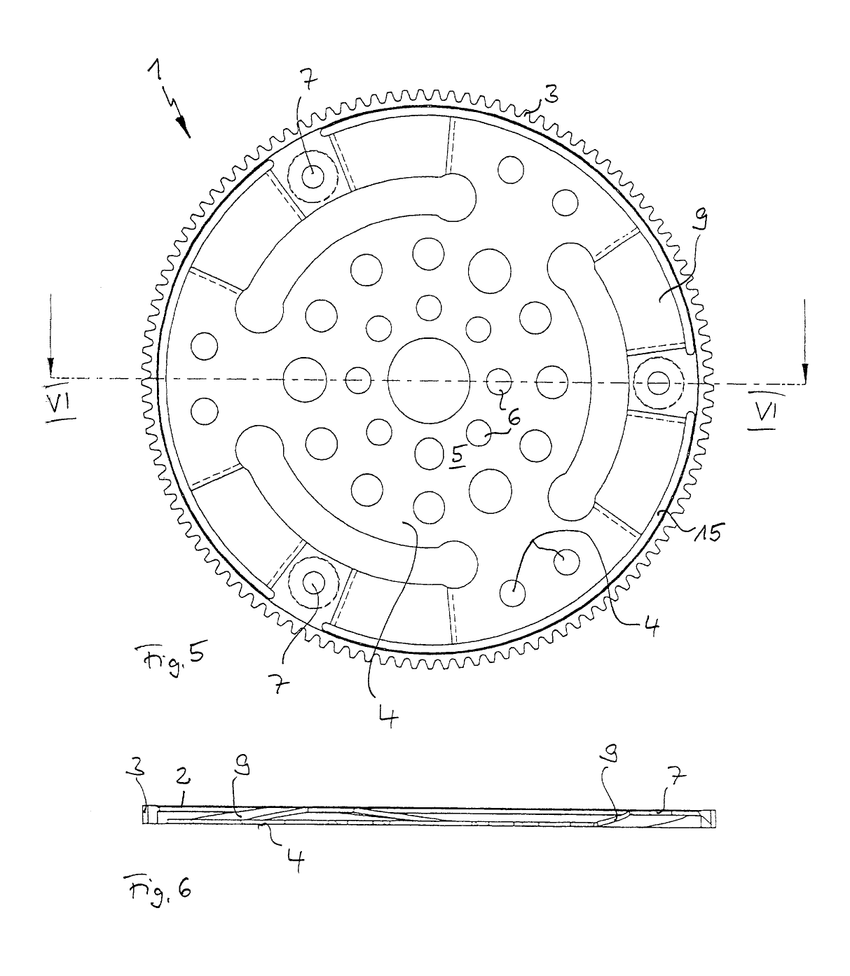

The embodiment according to FIGS. 5 and 6 is different from the one according to FIGS. 1 to 4 in that starter wheel 1 takes the form of one single component, i.e. starter element 2 is an integral component of disk-shaped driver element 4. For securing it on the converter, disk-shaped driver element 4 is provided with fastening openings 7 located in the radially outer area within toothed rim 3. The fastening openings are in turn arranged in rocker-like areas 9. In the present embodiment, the fastening openings are punched by sections from driver element 4 and reshaped so as to extend outwards correspondingly. The punched-out areas are denoted by the reference numeral 15.

The embodiment according to FIGS. 5 and 6 is not different from the embodiment according to FIGS. 1 to 4 in any other respect.

The invention is, of course, not limited to the exemplified embodiments shown. Other embodiments are possible without vacating the basic idea of the invention. For example, hub area 5 can be provided with an additional wall reinforcement, if necessary.

Accordingly, while a few embodiments of the present invention have been shown and described, it is to be understood that many changes and modifications may be made thereunto without departing from the spirit and scope of the invention as defined in the appended claims.

What is claimed is:

1. A starter wheel adapted to be secured to a motor shaft of a vehicle having an automatic transmission with a converter, which comprises:
(a) a starter element having an outer circumference;
(b) a toothed rim on the outer circumference of said starter element; and
(c) a driver element connected with said starter element, said driver element comprising flexible rocker areas bulging axially outwards adjacent to said toothed rim in an area of said driver element adapted for connection to the converter of the automatic transmission.

2. The starter wheel according to claim 1 wherein said starter element is ring-shaped, said driver element is a disk disposed within said starter element, and each of said starter element and said driver element has at least one fastening opening serving as connecting means for jointly securing said starter element and said driver element to the converter of an automatic transmission.

3. The starter wheel according to claim 2 wherein said starter element and said driver element are secured to each other in the area of said fastening openings.

4. The starter wheel according to claim 1 wherein said starter element and said driver element are formed as an integral unit.

5. The starter wheel according to claim 1 wherein said starter element has the shape of a disk, said driver element has the shape of a ring, and said driver element is connected with said starter element between said rocker areas.

6. The starter wheel according to claim 1 further comprising a plurality of relief bores distributed throughout said driver element.

7. The starter wheel according to claim 6 wherein said relief bores are arranged in a pattern in said driver element.

8. The starter wheel according to claim 7 wherein at least some of said relief bores are oblong holes.

9. The starter wheel according to claim 6 wherein at least some of said relief bores are provided between said rocker areas at approximately the radial location of said fastening openings.
